(19) United States
(12) Patent Application Publication
(10) Pub. No.: US 2026/0251468 A1
(43) Pub. Date: Aug. 27, 2026

(54) INFORMATION PROCESSING DEVICE

(71) Applicant: TOYOTA JIDOSHA KABUSHIKI KAISHA, Toyota-shi (JP)

(72) Inventors: Mitsuhiro ONO, Yokosuka-shi (JP); Kiminobu MAKINO, Tokyo (JP); Naoto MATSUMOTO, Tokyo (JP); Takuya YOSHIDA, Tokyo (JP); Hiroki KANO, Yokohama-shi (JP); Junya OIKAWA, Kawasaki-shi (JP)

(73) Assignee: TOYOTA JIDOSHA KABUSHIKI KAISHA, Toyota-shi (JP)

(21) Appl. No.: 19/421,607

(22) Filed: Dec. 16, 2025

(30) Foreign Application Priority Data
Feb. 25, 2025 (JP) 2025-027589

(51) Int. Cl. G01C 21/34; B60L 58/12; G01C 21/36

(52) U.S. Cl. CPC G01C 21/3469; B60L 58/12; G01C 21/3492; G01C 21/3679; G01C 21/3691; B60L 2240/66; B60L 2240/68; B60L 2240/72

(57) ABSTRACT

An information processing device provides information to a vehicle equipped with a storage battery. The information processing device includes a control unit configured to determine whether surplus electricity is expected to be generated at a predetermined time at any one of a plurality of power plants configured to generate electricity using renewable energy, based on whether an amount of electricity generatable by the power plant at the predetermined time exceeds an amount of electricity to be used by consumers supplied with electricity from the power plant; and when determination is made that the surplus electricity is expected to be generated at any one of the power plants, transmit, to the vehicle equipped with the storage battery, information indicating that charging of the storage battery is possible at the predetermined time at a location corresponding to the power plant determined to generate the surplus electricity.

### CROSS-REFERENCE TO RELATED APPLICATION

This application claims priority to Japanese Patent Application No. 2025-027589 filed on February 25, 2025. The disclosure of the above-identified application, including the specification, drawings, and claims, is incorporated by reference herein in its entirety.

### BACKGROUND

### 1. Technical Field

The present disclosure relates to information processing devices that provide information to a vehicle.

### 2. Description of Related Art

There are technologies for controlling the charging and discharging of storage batteries installed in vehicles. For example, Japanese Unexamined Patent Application Publication No. 2024-44847 (JP 2024-44847 A) discloses a power supply and demand control system that controls the charging or discharging of a storage battery installed in a vehicle connected to a power grid, such that the state of charge (SOC) of the storage battery reaches a target SOC determined based on the amount of power consumption expected during a single use of the vehicle.

### SUMMARY

An object of the information processing device according to the present disclosure is to encourage a vehicle equipped with a storage battery to make use of surplus electricity generated at a power plant.

One aspect of the present disclosure is an information processing device configured to provide information to a vehicle equipped with a storage battery. The information processing device includes a control unit configured to: determine whether surplus electricity is expected to be generated at a predetermined time at any one of a plurality of power plants configured to generate electricity using renewable energy, based on whether an amount of electricity generatable by the power plant at the predetermined time exceeds an amount of electricity to be used by consumers supplied with electricity from the power plant; and when determination is made that the surplus electricity is expected to be generated at any one of the power plants, transmit, to the vehicle equipped with the storage battery, information indicating that charging of the storage battery is possible at the predetermined time at a location corresponding to the power plant determined to generate the surplus electricity.

Other aspects include an information processing method executed by the above-described information processing device, a program for causing a computer to execute the information processing method, or a non-transitory computer-readable storage medium storing the program in a non-transitory manner.

The information processing device according to the present disclosure encourages a vehicle equipped with a storage battery to make use of surplus electricity generated at a power plant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of processing executed by a server device according to a first embodiment;

FIG. 2 is a diagram illustrating components of the server device according to the first embodiment;

FIG. 3 is a flowchart illustrating processing executed by the server device according to the first embodiment; and

FIG. 4 is a flowchart illustrating processing executed by a server device according to a second embodiment.

### DETAILED DESCRIPTION OF EMBODIMENTS

### Overview

Regulating the charging and discharging of storage batteries connected to a power grid plays a key role in maintaining grid stability.

In this regard, there are technologies for controlling the charging and discharging of storage batteries installed in vehicles connected to the power grid.

For example, a conventional power supply and demand control system estimates the amount of power consumption for a single use of a vehicle, and controls the charging or discharging of the storage battery of the vehicle such that the target SOC, determined based on the estimated power consumption, is achieved. As used herein, SOC refers to a measure of the charge level of a storage battery, defined as 100% when fully charged and 0% when completely discharged.

Specifically, the conventional power supply and demand control system is communicably connected to the vehicle and stores records of the vehicle's past usage. The power supply and demand control system estimates the amount of power consumption for a single use of the vehicle based on these records, and determines the target SOC of the storage battery from the estimated power consumption. The power supply and demand control system then controls the charging or discharging of the storage battery such that its SOC reaches the target SOC.

However, conventional power supply and demand control systems still leave room for improvement. For example, consider a power grid that receives electricity from power plants using renewable energy, where the amount of power generation fluctuates depending on weather conditions. In such a power grid, surplus electricity may occur locally under certain environmental conditions. For the stability of the power grid, it is desirable that this surplus electricity can be consumed on-site as it becomes available. However, in such a power grid, the amount of electricity supplied fluctuates relatively greatly. As a result, it is difficult to ensure battery capacity sufficient to stabilize the power grid solely by controlling the charging and discharging of storage batteries in vehicles that are currently present at the site. On the other hand, securing a large amount of battery capacity in advance to match the temporarily generated surplus electricity would be economically inefficient.

An information processing device according to one aspect of the present disclosure is configured to provide information to a vehicle equipped with a storage battery. The information processing device includes a control unit configured to: determine whether surplus electricity is expected to be generated at a predetermined time at any one of a plurality of power plants configured to generate electricity using renewable energy, based on whether an amount of electricity generatable by the power plant at the predetermined time exceeds an amount of electricity to be used by consumers supplied with electricity from the power plant; and when determination is made that the surplus electricity is expected to be generated at any one of the power plants, transmit, to the vehicle equipped with the storage battery, information indicating that charging of the storage battery is possible at the predetermined time at a location corresponding to the power plant determined to generate the surplus electricity.

The term "surplus electricity" refers to an amount of electricity that remains unused when the amount of electricity consumed by consumers supplied with electricity from a power plant is less than the amount of electricity generatable by the power plant.

The phrase "location corresponding to the power plant" refers to a specific location associated with the target power plant. The location corresponding to the power plant is a location where a facility capable of charging the storage battery of a vehicle is located. Specifically, this location may be the power plant itself or a charging spot located within a predetermined distance from the power plant.

The control unit determines whether surplus electricity is expected to be generated at a predetermined power plant. When determination is made that surplus electricity is expected to be generated at the predetermined power plant, the control unit transmits, to a vehicle, information indicating that charging of the storage battery is possible at the location corresponding to the power plant.

As described above, when surplus electricity is generated, a vehicle equipped with a storage battery moves to the vicinity of the power plant where the surplus electricity is being generated, and charges its storage battery. In this way, surplus electricity can be consumed on-site as needed, even without constantly securing a large amount of battery capacity.

With this configuration, the information processing device according to the present disclosure can encourage a vehicle equipped with a storage battery to make use of surplus electricity generated at a power plant.

The control unit may be configured to transmit the information to the vehicle that is able to arrive at the power plant by the predetermined time at which the surplus electricity is generated at the power plant.

The control unit may be configured to determine the vehicle to which the information is to be transmitted, based on an amount of the surplus electricity and an amount of capacity available for charging in the storage battery of the vehicle.

The information processing device according to the present disclosure can thus select a vehicle that can actually consume the surplus electricity and transmit the information to the vehicle.

The control unit may be configured to determine whether the surplus electricity is expected to be generated at the power plant, based on a weather forecast for the predetermine time at a location where the power plant is located.

The control unit may be configured to determine whether the surplus electricity is expected to be generated at the power plant based on predicted human traffic for the predetermined time at a location where the power plant is located.

With this configuration, the information processing device according to the present disclosure can accurately determine whether surplus electricity is expected to be generated.

Specific embodiments of the present disclosure will now be described with reference to the drawings. Unless otherwise specified, the hardware configuration, module configuration, functional configuration, etc. described in each embodiment are not intended to limit the technical scope of the present disclosure to those.

### First Embodiment

### Overview of Processing Executed by Server Device

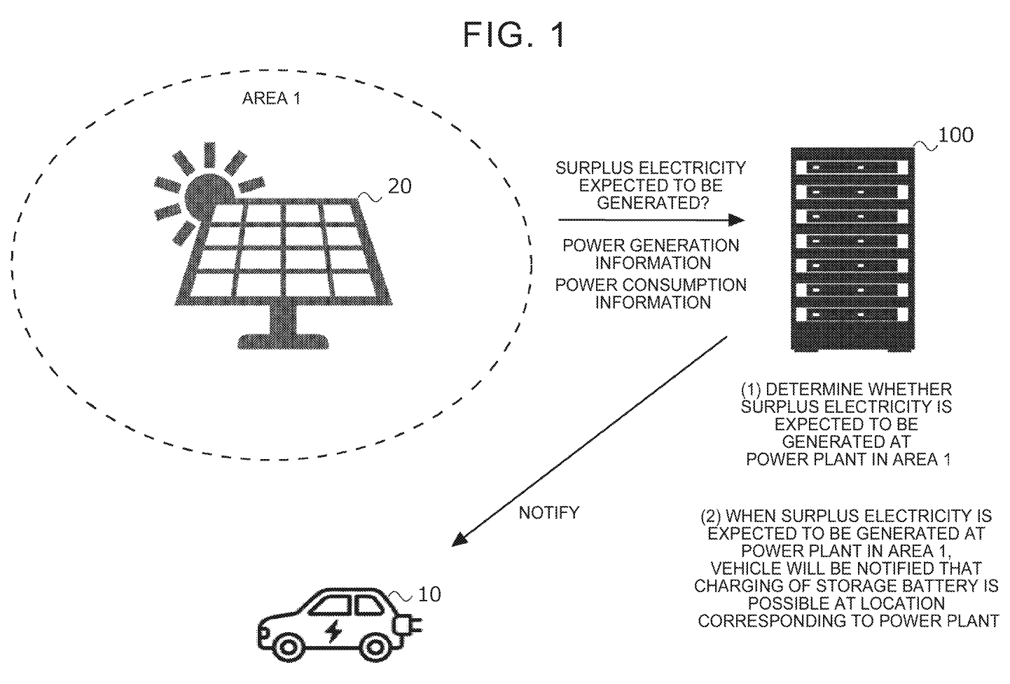

An overview of the processing executed by a server device according to a first embodiment will be described with reference to FIG. 1. FIG. 1 is a diagram illustrating an overview of the processing executed by a server device 100 according to the first embodiment. The information processing device according to the aspect of the present disclosure is implemented as the server device 100.

The server device 100 determines whether surplus electricity is expected to be generated at a power plant 20 located in a predetermined area (e.g., Area 1). The server device 100 acquires, from external devices, information used to predict the amount of power generated at the power plant 20 (hereinafter referred to as "power generation information") and information used to predict the amount of power consumed by consumers in the area where the power plant 20 is located (herein referred to as "power consumption information"). The server device 100 calculates the expected power generation amount and power consumption amount based on the power generation information and the power consumption information, and determines whether surplus electricity is expected to be generated at the power plant 20 by comparing the expected power generation and consumption amounts.

The power generation information may be information on the weather in the vicinity of the power plant 20, and the server device 100 may predict the power generation amount of the power plant 20 based on the weather in the vicinity of the power plant 20. The power plant 20 is a facility that generates electricity using renewable energy.

The power consumption information may be information on human traffic in the area (e.g., Area 1) served by the power plant 20, and the server device 100 may predict the amount of power consumption in the area based on this human traffic information.

When the server device 100 determines that surplus electricity is expected to be generated in the area served by the power plant 20 (Area 1), it notifies a vehicle 10 that charging of its storage battery is possible at a location corresponding to the power plant 20.

This allows the server device 100 to encourage the vehicle 10 to charge its storage battery at a location corresponding to the power plant 20, such as in the vicinity of the power plant 20. The server device 100 can thus enable surplus electricity generated at the power plant 20 to be consumed in the vicinity of the generation site of the surplus electricity.

Accordingly, the server device 100 according to the embodiment can facilitate the effective use of surplus electricity generated at the power plant by utilizing vehicles equipped with storage batteries.

### Configuration of Server Device

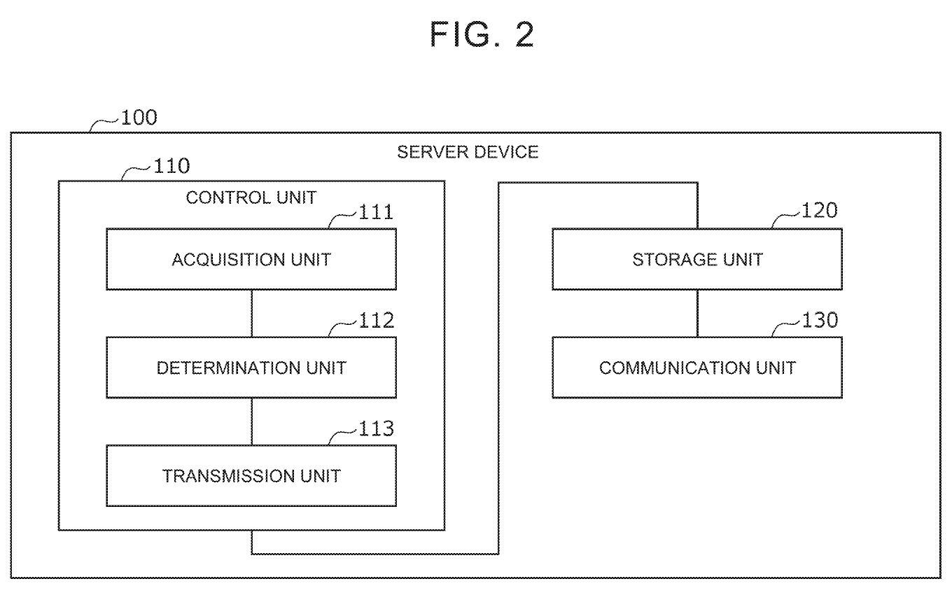

Next, the hardware and software configurations of the system including the server device 100 will be described. FIG. 2 is a diagram illustrating the components of the server device 100 according to the first embodiment.

The server device 100 can be configured as a computer that includes a processor (such as central processing unit (CPU) or graphics processing unit (GPU)), a main storage device (such as random access memory (RAM) or read-only memory (ROM)), and an auxiliary storage device (such as erasable programmable read-only memory (EPROM), hard disk drive, or removable media). The auxiliary storage device stores an operating system (OS), various programs, tables, etc. By executing the programs stored therein, it is possible to implement various functions (software modules) aligned with predetermined purposes, as described later. Some or all of these functions may be implemented as hardware modules using a hardware circuit such as an application-specific integrated circuit (ASIC) or a field-programmable gate array (FPGA).

The server device 100 includes a control unit 110, a storage unit 120, and a communication unit 130.

The control unit 110 is a computation unit that implements various functions of the server device 100 by executing a predetermined program. The control unit 110 may be implemented by a hardware processor such as a central processing unit (CPU). The control unit 110 may also include RAM, ROM, cache memory, etc.

In the present embodiment, the control unit 110 of the server device 100 includes three software modules: an acquisition unit 111, a determination unit 112, and a transmission unit 113. Each software module may be implemented by executing a program stored in the storage unit 120 using the control unit 110 (e.g., a CPU). The information processing executed by these software modules is equivalent to the information processing executed by the control unit 110 (e.g., a CPU)

The acquisition unit 111 acquires various types of information used by the determination unit 112 to determine whether surplus electricity is expected to be generated at each power plant. Specifically, the acquisition unit 111 acquires information used to predict the amount of power generated at each power plant (hereinafter referred to as "power generation information") and information used to predict the amount of power consumed by consumers in the area where each power plant is located (herein referred to as "power consumption information"). For example, the acquisition unit 111 may acquire, as the power generation information, information on the weather at a predetermined time in the area where each power plant is located (herein referred to as "weather information"). The acquisition unit 111 may also acquire, as the power consumption information, information on human traffic at a predetermined time in the area where each power plant is located.

The determination unit 112 determines, based on the information acquired by the acquisition unit 111, whether surplus electricity is expected to be generated at a predetermined time at each power plant located within the managed region. When, in the area where a given power plant is located, the amount of power generated by the power plant at the predetermined time is determined to exceed the amount of power consumed by consumers in that area at that time, the determination unit 112 determines that surplus electricity is expected to be generated at the power plant.

The determination unit 112 determines, for each power plant located in a predetermined region including multiple areas (e.g., Areas 1 to 3), whether surplus electricity is expected to be generated at the power plant. Each power plant uses renewable energy such as solar power. For example, the determination unit 112 determines the amount of power generated by each power plant based on the weather in each of Areas 1 to 3 at a predetermined time. At the same time, the determination unit 112 predicts the amount of power consumed by consumers in Areas 1 to 3 at the predetermined time. When there is an area where the amount of power consumed by consumers is lower than the amount of power generated by the power plant, the determination unit 112 determines that surplus electricity is expected to be generated at the power plant in that area at the predetermined time.

When the determination unit 112 determines that surplus electricity is expected to be generated at a given power plant, the transmission unit 113 transmits, to the vehicle 10, information indicating that charging of the storage battery of the vehicle 10 is possible at the power plant or at any location within the area in which the power plant is located (hereinafter referred to as "first information").

When the determination unit 112 determines, for example, that surplus electricity is expected to be generated at the power plant 20 in Area 1, the transmission unit 113 determines that charging of the storage battery of the vehicle 10 is possible at the power plant 20 in Area 1, and transmits information indicating this to the vehicle 10. The determination unit 112 may determine that charging of the storage battery of the vehicle 10 is possible at any location within Area 1, for example, instead of at the power plant 20 in Area 1, and the transmission unit 113 may transmit information indicating this to the vehicle 10. That is, the transmission unit 113 identifies, among the power plants in each area of the managed region, a power plant that is expected to generate surplus electricity, and transmits information to the vehicle 10 indicating that charging of the storage battery of the vehicle 10 is possible at a location corresponding to the identified power plant (for example, at any location within the area where the power plant is located).

The storage unit 120 is means for storing information and is constituted by a storage medium such as RAM, magnetic disk, or flash memory. The storage unit 120 stores programs executed by the control unit 110, data used by those programs, etc.

The communication unit 130 is a wireless communication interface for connecting the server device 100 to an external network. The communication unit 130 may be configured to communicate with external devices via, for example, a wireless local area network (LAN) or a cellular network such as 3G, 4G, or 5G.

The configuration shown in FIG. 2 is merely an example, and all or part of the illustrated functions may be implemented using dedicated circuits. Programs may be stored or executed by a combination of main and auxiliary storage devices other than the combination illustrated in the figures.

### Processing of Server Device

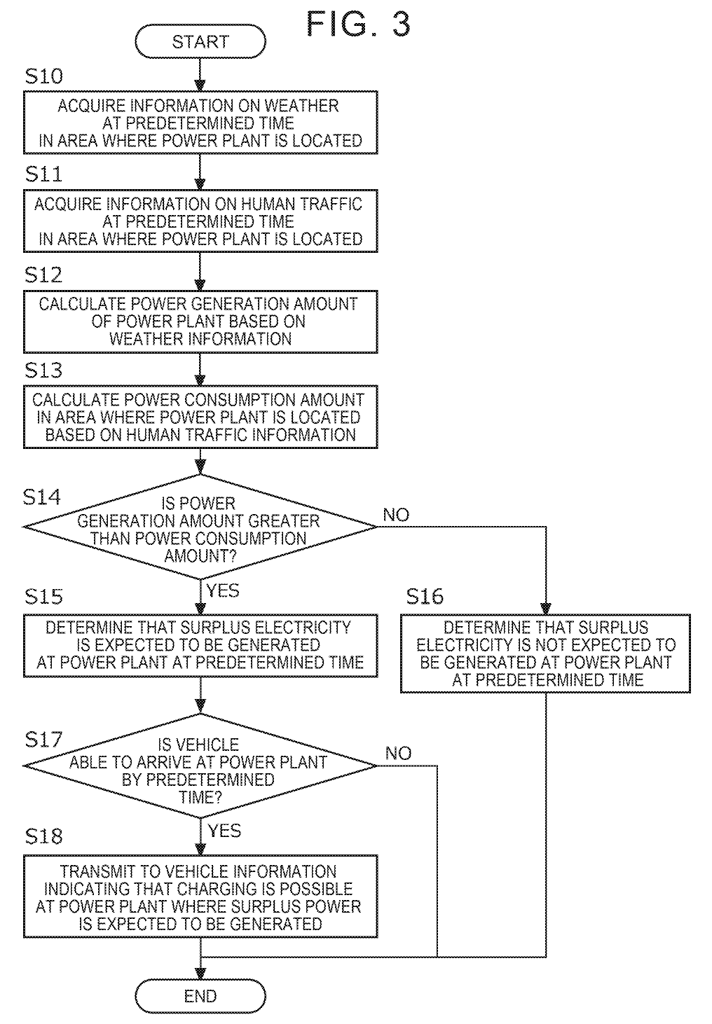

Next, the specific processing executed by the server device 100 according to the embodiment of the present disclosure will be described. FIG. 3 is a flowchart showing the processing executed by the server device 100 according to the first embodiment. FIG. 3 illustrates processing in which, when the server device 100 determines that surplus electricity is expected to be generated at a given power plant, it sends information to the vehicle 10 indicating that charging of the storage battery is possible at a location corresponding to the power plant.

The server device 100 starts the processing in step S10 at predetermined intervals. For example, the server device 100 may start the processing in step S10 every 30 minutes.

In step S10, the acquisition unit 111 acquires information on the weather at a predetermined time at a predetermined power plant (i.e., weather information). The predetermined power plant generates electricity using renewable energy. The renewable energy is, for example, solar power or wind power.

The acquisition unit 111 communicates with an external server via the communication unit 130 to acquire the weather information. The weather information may be an hourly forecast in a predetermined area. The display of weather in the weather information is not limited to hourly intervals, and may be provided in predetermined time intervals. The weather in the weather information may be represented, for example, using expressions such as clear, sunny, cloudy, rainy, or snowy for each predetermined time period in the predetermined area. Alternatively, the amount of cloud cover for each predetermined time period in the predetermined area may be represented as a percentage. The weather information may include wind speed information for each predetermined time period in the predetermined area.

Next, in step S11, the acquisition unit 111 acquires information on human traffic at a predetermined time in the area where the power plant is located (i.e., human traffic information). The acquisition unit 111 communicates with an external server via the communication unit 130 to obtain the human traffic information. The human traffic information may be, for example, aggregated data showing how many mobile phones were recognized by base stations at each location at predetermined intervals (e.g., every hour), or may be aggregated data showing how many vehicles capable of communication were recognized. The format and content of the human traffic data are not limited to these examples. The entity measuring the human traffic data is not limited to base stations and may be any terminal or sensor.

Next, in step S12, the determination unit 112 calculates the amount of power generated by the power plant at a predetermined time, based on the weather information. For example, the determination unit 112 may estimate the current power generation amount of the power plant based on current weather information, or may predict the power generation amount at a future time based on weather information for the future time. For example, when the power plant in a predetermined area generates electricity using solar power, the determination unit 112 may calculate a higher amount of power generation in the area when the weather in the area is clear, compared to when the weather in the area is cloudy or rainy.

Specifically, when the power plant generates electricity using solar power, the determination unit 112 may calculate the power generation amount of the power plant based on the cloud cover in the vicinity of the power plant at the predetermined time. For example, the determination unit 112 may calculate a higher amount of power generation when the cloud cover in the vicinity of the power plant at the predetermined time is lower. For example, when the power plant generates electricity using wind power, the determination unit 112 may calculate the power generation amount of the power plant based on the wind speed and wind volume in the vicinity of the power plant at the predetermined time. For example, the determination unit 112 may calculate a higher amount of power generation when the wind speed or the wind volume in the vicinity of the power plant at the predetermined time is higher.

Thereafter, in step S13, the determination unit 112 calculates the amount of power consumption in the area where the power plant is located at the predetermined time, based on the human traffic information. For example, the determination unit 112 may estimate the current power consumption in the area based on the current human traffic information, or predict the power consumption at a future time in the area based on human traffic information (predicted information) for the future time.

For example, the determination unit 112 may calculate the amount of power consumption at the predetermined time in the area where the power plant is located, based on the amount of human traffic in the area at the predetermined time. As an example, the determination unit 112 may calculate a greater amount of power consumption when the amount of human traffic in the area at the predetermined time is larger.

Subsequently, in step S14, the determination unit 112 determines whether, at the predetermined time, the power generation amount calculated in step S12 is greater than the power consumption amount calculated in step S13. The predetermined time is determined based on the time indicated by the power generation information and the power consumption information. The determination in this step is YES when the determination unit 112 determines that, at the predetermined time, the power generation amount calculated in step S12 exceeds the power consumption amount calculated in step S13.

When YES in step S14, the process proceeds to step S15.

When NO in step S14, the process proceeds to step S16.

When the process proceeds to step S15, the determination unit 112 determines that surplus electricity is expected to be generated at the power plant at the predetermined time.

When the process proceeds to step S16, the determination unit 112 determines that surplus electricity is not expected to be generated at the power plant at the predetermined time.

Thereafter, in step S17, the transmission unit 113 determines whether the vehicle 10 can arrive, by the predetermined time, at the power plant determined to generate surplus electricity (hereinafter referred to as "surplus power plant") or at any location within the area where the surplus power plant is located. When the vehicle 10 is located within a range from which it can reach the surplus power plant or any location in the area where the surplus power plant is located by the predetermined time, the transmission unit 113 determines that the vehicle 10 can arrive at the surplus power plant or such a location by the predetermined time. For example, the transmission unit 113 may acquire position information indicating the traveling positions of a plurality of vehicles 10 traveling within the managed region and make the above determination.

Subsequently, in step S18, the transmission unit 113 transmits, to the vehicle 10 determined in step S17 to be able to arrive, by the predetermined time, at the surplus power plant or at any location within the area where the surplus power plant is located, information (first information) indicating that charging of the storage battery is possible at the surplus power plant or at the location.

For example, the first information may include location information of a charging spot at which the vehicle 10 can charge its storage battery. The first information may also include, for example, location information of the surplus power plant or any location within the area where the surplus power plant is located, information indicating the time period during which charging is possible, or information indicating the amount of electricity that can be supplied to charge the storage battery.

As described above, the server device 100 of the present embodiment determines whether surplus electricity is expected to be generated at a predetermined power plant. When it is determined that surplus electricity is expected to be generated at the power plant, the server device 100 transmits, to a vehicle that can arrive at the power plant or other location by the predetermined time, information indicating that charging of the storage battery is possible at the power plant or other location. The server device 100 can thus facilitate effective use of the surplus electricity generated at the power plant by utilizing vehicles equipped with storage batteries.

### Second Embodiment

In the first embodiment, when it is determined that surplus electricity is expected to be generated at a given power plant ("surplus power plant") at a predetermined time, information ("first information") indicating that charging of the storage battery is possible at the surplus power plant or other location is transmitted to a vehicle 10 that can arrive at the surplus power plant or other location by that time. However, the storage battery of the vehicle 10 that can arrive at the surplus power plant or other location by the predetermined time does not necessarily have capacity available for charging. Therefore, in the second embodiment, the first information is transmitted to a vehicle 10 whose storage battery has at least a predetermined amount of capacity available for charging.

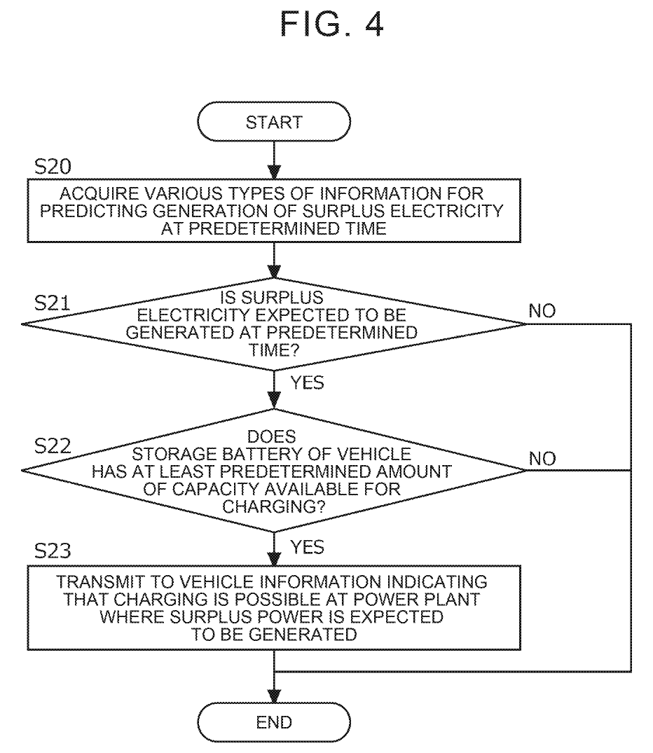

FIG. 4 is a flowchart of the processing executed by the server device 100 according to the second embodiment. The processing in FIG. 4 is executed in place of the processing in FIG. 3 of the first embodiment. Note that, regarding the processing in FIG. 4, description of the same processing as that described in FIG. 3 will be omitted.

First, in step S20, the acquisition unit 111 acquires various types of information for predicting generation of surplus electricity at a predetermined time. Step S20 is the same as steps S10 and S11 in FIG. 3.

Next, in step S21, the determination unit 112 determines whether surplus electricity is expected to be generated at any of the power plants at the predetermined time. Step S21 corresponds to step S15 or S16 in FIG. 3. In this step, the determination is YES when the determination unit 112 determines that surplus electricity is expected to be generated at any of the power plants at the predetermined time.

When YES in step S21, the process proceeds to step S22.

When NO in step S21, the process ends.

When the process proceeds to step S22, the transmission unit 113 determines whether the storage battery of the vehicle 10 has at least a predetermined amount of capacity available for charging. Specifically, the transmission unit 113 acquires, from each of vehicles 10 traveling within the managed region, information indicating how much capacity of the storage battery of the vehicle 10 is available for charging, and determines, for each vehicle 10, whether the storage battery has at least the predetermined amount of capacity for charging. The information indicating how much capacity of the storage battery is available for charging may be expressed as a percentage relative to the total capacity of the storage capacity, or as an absolute value of the capacity available for charging. In this step, the determination is YES when the transmission unit 113 determines that the storage battery of the vehicle 10 has at least the predetermined amount of capacity available for charging.

When YES in this step, the process proceeds to step S23.

When NO in this step, the process ends.

When the processing transitions to step S23, the transmission unit 113 transmits, to the vehicle 10 determined in step S22 to have at least the predetermined amount of capacity available for charging in its storage battery, information (first information) indicating that charging of the storage battery is possible at the location corresponding to the surplus power plant. Step S23 is the same as step S18 in FIG. 3.

As described above, the server device 100 of the second embodiment can transmit, to a vehicle equipped with a storage battery with sufficient capacity available for charging, information indicating that charging of the storage battery is possible at a surplus power plant or other location. Accordingly, the server device 100 of the second embodiment can facilitate the effective use of surplus electricity by utilizing vehicles equipped with storage batteries.

### Other Modifications

The above embodiment is merely an example, and the present disclosure may be modified as appropriate without departing from the spirit of the disclosure. For example, the processes and means described in the present disclosure may be combined and implemented as desired, as long as no technical inconsistencies arise.

In step S13 of FIG. 3, instead of calculating the amount of power consumption based on the human flow information, the determination unit 112 may calculate the amount of power consumption in each area based on information indicating scheduled activities in the area. In this case, the determination unit 112 may calculate a higher amount of power consumption for larger-scale activities. The scale of the activity may be considered to be larger when the geographical area in which the activity is carried out is larger, or may be considered to be larger when the energy consumption of the processes performed in the activity is larger.

The transmission unit 113 transmits the first information to a vehicle 10 that can arrive at a power plant determined to generate surplus electricity at a predetermined time (surplus power plant) by the predetermined time, or to a vehicle 10 equipped with a storage battery having sufficient capacity available for charging. However, the present disclosure is not limited to this. The transmission unit 113 may transmit the first information to a vehicle 10 that can arrive at the surplus power plant by the predetermined time and is equipped with a storage battery having sufficient capacity available for charging.

The present disclosure may also be implemented by supplying a computer with a computer program that implements the functions described in the above embodiments, and causing one or more processors in the computer to read and execute the program. Such a computer program may be provided to the computer via a non-transitory computer-readable storage medium connectable to the computer's system bus, or may be provided to the computer via a network. Examples of the non-transitory computer-readable storage medium include: any types of disks such as magnetic disks (floppy (registered trademark) disks, hard disk drives (HDDs), etc.), optical disks (compact disc-read only memories (CD-ROMs), digital versatile discs (DVDs), Blu-ray discs, etc.); read-only memory (ROM); random access memory (RAM); erasable programmable read-only memory (EPROM); electrically erasable programmable read-only memory (EEPROM); magnetic cards; flash memory; optical cards; and any types of medium suitable for storing electronic instructions.

What is claimed is:

1. An information processing device configured to provide information to a vehicle equipped with a storage battery, the information processing device comprising a control unit configured to
determine whether surplus electricity is expected to be generated at a predetermined time at any one of a plurality of power plants configured to generate electricity using renewable energy, based on whether an amount of electricity generatable by the power plant at the predetermined time exceeds an amount of electricity to be used by consumers supplied with electricity from the power plant, and
when determination is made that the surplus electricity is expected to be generated at any one of the power plants,
transmit, to the vehicle equipped with the storage battery, information indicating that charging of the storage battery is possible at the predetermined time at a location corresponding to the power plant determined to generate the surplus electricity.

2. The information processing device according to claim 1, wherein the control unit is configured to transmit the information to the vehicle that is able to arrive at the power plant by the predetermined time at which the surplus electricity is generated at the power plant.

3. The information processing device according to claim 1, wherein the control unit is configured to determine the vehicle to which the information is to be transmitted, based on an amount of the surplus electricity and an amount of capacity available for charging in the storage battery of the vehicle.

4. The information processing device according to claim 1, wherein the control unit is configured to determine whether the surplus electricity is expected to be generated at the power plant, based on a weather forecast for the predetermined time at a location where the power plant is located.

5. The information processing device according to claim 1, wherein the control unit is configured to determine whether the surplus electricity is expected to be generated at the power plant based on predicted human traffic for the predetermined time at a location where the power plant is located.
